(19) United States
(12) Patent Application Publication
(10) Pub. No.: US 2009/0164408 A1
(43) Pub. Date: Jun. 25, 2009

(54) Method, System and Computer Program for Managing Delivery of Online Content

(76) Inventors: Ilya Grigorik, Burlington (CA); Kevin Thomason, Waterloo (CA)

Correspondence Address: MILLER THOMPSON, LLP, Scotia Plaza, 40 King Street West, Suite 5800, TORONTO, ON, M5H 3S1, CA

(21) Appl. No.: 11/962,961

(22) Filed: Dec. 21, 2007

(51) Int. Cl. G06F 17/30

(52) U.S. Cl. 707/1; 707/E17.005

(57) ABSTRACT

A method for delivering online content is provided including the steps of (a) providing access to online content including a plurality of data objects; (b) obtaining information regarding the relevance of and/or likelihood of interest in the data objects by searching for online social engagement with the data objects by one or more users, so as to define social engagement data; and (c) ranking and/or filtering the data objects for relevance of and/or likelihood of interest based on the social engagement data. A system and computer program for online content delivery is also provided.

### FIELD OF INVENTION

The present invention relates to the electronic identification of sought-after data objects in an electronic media environment based on user determined selection criteria. The present invention relates more particularly to online content delivery systems based on likely interest to a user.

### BACKGROUND

Information networks are growing at a tremendous pace and the amount of electronic media, such as on-line information sources, can provide an overwhelming amount of information to users and publishers. Users of the electronic media environment sometimes have difficulty in finding relevant information and content providers often have problems delivering information to the user that is of interest to them.

Information overload may occur as both the user sifts through a sometimes excessive amount of information to find desired items. Similarly, publishers may be required to spend significant efforts in presenting information that may be of interest to a user before providing information that is actually of interest to the user. For example, the user and the publisher may either fail to access the sought-after data objects because they are not easily identified or expend a significant amount of time and energy to perform an extensive search of relevant data objects such as news articles to identify those to be of interest. Prior art web content searching techniques and technologies generally do not provide adequate means for assessing the quality of a data object (such as a news article) for possible interest to a user.

The most widely adopted method of information retrieval is based on keyword filtering where the user specifies a set of keywords or phrases which the user thinks are contained in the desired articles and an information retrieval system retrieves all objects which contain those keywords or phrases. Such retrieval methods are fast and easy to setup but may also be unreliable, as users may not think of the right keywords or phrases, may omit semantic equivalents, and may receive many spurious results when the specified keywords and phrases appear in unwanted articles in an irrelevant or an unexpected context. Thus, keyword and phrase filtering is generally unable to offer the required granularity to capture ambiguous concepts or topics, and often results in inaccurate search results.

Starting in 1960's, a series of alternate approaches to information retrieval has been developed where personalization, collaborative, social, and clustering approaches have received attention. In such systems, articles, publishers, and users are often described by a profile which is comprised of either a list of the explicit or implicit preferences, keywords, or other representations of interest. In these social and collaborative approaches to information retrieval, explicit or implicit preference information is generally collected from the user into a repository where a measure of similarity between users and articles is defined as a function of distance between their profiles. Such data is then used in the process of article retrieval by first constructing a profile of the request and then retrieving articles with profiles similar to the profile generated for the request.

A social filtering system for net news is presented for example in Maltz, A D., “Distributed information for collaborative filtering on usenet net news”, Masters Thesis, MIT. In the system described in this publication, each user can read an article and vote for or against it. The votes are then sent to a vote server where the votes are grouped together and shared with other vote servers. The servers aggregate all the different readers' opinions into one collective opinion. This aggregated opinion can then either be used by news-readers to filter shown articles, or if two users have approximately the same opinions for most of the articles in a group, but they have not read them all, then it is likely that the users would like the unread documents of the group too.

A number of researchers have looked at methods for selecting articles of most interest to users based on their past explicit or implicit feedback profiles. Such systems commonly provide a service, or an agent, which filters interesting documents against a recorded user profile. Active or passive feedback, often commonly referred to as implicit or explicit responses from the user, is then recorded and future recommendations are adjusted correspondingly. If the pages do not match the user's profile they are not presented to the user.

One problem with collaborative, social, and personalization approaches is that of so-called cold start. The cold start problem means that the agent has no knowledge of the preferences of the user when it starts. It must have some time to learn what preferences the user has and during that time the information system generally does not perform very well.

Furthermore, in practice, only a small number of users even bother to respond to the feedback and preference requests, and conventional relevancy ratings are thus often not accurate predictions of the usefulness or the relevance of an article or object. Hence, the collaborative filtering approach may not work well if the users do not participate in the ratings process of objects or articles. A typical user prefers to minimize their time of interaction with the information system and is usually unwilling to spend extra time to provide additional feedback.

Another problem with content and similarity based approaches is so called serendipity problems, which means that there is a problem for the user or publisher to find information of which it has no knowledge and possibly of a type that it may not have encountered previously. Such information might be filtered out by the information system since it might believe that information is not interesting.

A number of other researchers have looked at automatic generation and labelling of clusters, meme detection, and taxonomy classification of articles for the purposes of article summarization, aggregation and surfacing of replicated content. Such methods are often capable of consolidating a large number of sources to determine popular articles, or other forms of electronic media references across numerous sources. A group at Xerox PARC published a paper titled “Scatter/gatherer: a cluster-based approach to browsing large article collections” at the 15 Ann. Int'l SIGIR '92, ACM 318-329, (Cutting et al. 1992). In this method, a collection of articles is scattered into a small number of clusters, the user then chooses one or more of these clusters based on short summaries of the cluster.

A major problem with automatic generation and labelling of clusters is that of establishing and maintaining a taxonomy for the clustering process. Since the true number of clusters is not known, and differs for every user, the results may be unreliable and prior art systems of this type are often unable to successfully classify objects and articles which do not have sufficient coverage or follow-up, resulting in poor filter and classification performance.

U.S. Pat. No. 6,029,195 issued to Herz teaches a system that creates a customized electronic identification of desirable objects. The Herz system updates user profiles over time to match user's interests with desirable objects. U.S. Pat. No. 5,717,923 issued to Intel Corporation, teaches a system that requires active feedback to create a personal profile to adapt content to user's preferences.

Therefore, in the field of information retrieval, what is needed is an efficient system which enables the user to effectively navigate through significant amounts of web content. There is a further need for a system, method, and computer program that enables intelligent filtering and customization of information delivery for web content that reflects users' unique tastes and interests. There is a further need for such a system, method, and computer program that is relatively unobtrusive, passive, and undemanding of the user. There is a further need for a system, method, and computer program enabling electronic identification of desirable data objects, such as news articles, that enables a user to access information of relevance and consistent with his/her level of interest without requiring the user to expend an excessive amount of time and energy.

### SUMMARY OF THE INVENTION

In one aspect of the invention, a method for delivering online content is provided comprising the steps of: (a) providing access to online content including a plurality of data objects; (b) obtaining information regarding the relevance of and/or likelihood of interest in the data objects by searching for online social engagement with the data objects by one or more users, so as to define social engagement data; and (c) ranking and/or filtering the data objects for relevance of and/or likelihood of interest based on the social engagement data.

In another aspect of the invention, an online content delivery system is provided comprising: (a) a server computer connected to an interconnected network of computers; and (b) a server application linked to the server computer, the server application including a data processing utility, the data processing utility being operable to enable the server computer to: (i) provide access to online content including a plurality of data objects; (ii) obtain information regarding the relevance of and/or likelihood of interest in the data objects by searching for online social engagement with the data objects by one or more users, so as to define social engagement data; and (iii) rank and/or filter the data objects for relevance and/or likelihood of interest based on the social engagement data.

In yet another aspect of the invention, a computer program for enabling online content delivery is provided comprising computer instructions, which when made available to a server computer define a server application, the server application including a data processing utility, the data processing utility being operable to enable the server computer to: (a) provide access to online content including a plurality of data objects; (b) obtain information regarding the relevance of and/or likelihood of interest in the data objects by searching for online social engagement with the data objects by one or more users, so as to define social engagement data; and (c) rank and/or filter the data objects for relevance and/or likelihood of interest based on the social engagement data.

In a further aspect of the invention, a computer program for enabling online content delivery is provided comprising computer instructions, which when made available to a computer defines on the computer a subscriber application, the subscriber application being operable to enable the computer to communicate with a server computer, the server computer including a server application, the subscriber application being operable to enable a subscriber to initiate the server application to: (a) provide access to online content including a plurality of data objects; (b) obtain information regarding the relevance of and/or likelihood of interest in the data objects by searching for online social engagement with the data objects by one or more users, so as to define social engagement data; and (c) rank and/or filter the data objects for relevance and/or likelihood of interest based on the social engagement data.

### BRIEF DESCRIPTION OF THE DRAWINGS

The present invention may be best understood with reference to the following figures, which are provided only as examples or particular embodiments of the present invention and are, therefore, not meant to limit the scope of the present invention.

FIG. 1 illustrates in block diagram form a network in accordance with the present invention.

FIG. 2 illustrates a data processing system in accordance with one aspect of the present invention.

FIG. 3 illustrates operation of the data processing system shown in FIG. 2, in accordance with an aspect of the present invention.

FIG. 4 is a flow diagram illustrating calculation of the social engagement metrics of an object in accordance with one aspect of the present invention.

FIG. 5 is a flow diagram illustrating identification of social engagement data which could be used as part of the method of FIG. 3 of one aspect of the present invention.

FIG. 6 illustrates in a flow diagram the operational steps that may be taken by the system for customized electronic identification of sought-after objects to filter articles for users in accordance with one aspect of the present invention.

FIG. 7 illustrates in a flow diagram the operational steps that may be taken by a user for customized electronic identification of desirable objects to filter articles for users in accordance with one aspect of the present invention.

FIG. 8 illustrates a schematic view showing a flow of identification of sought-after objects process that may be performed by the system in accordance with one aspect of the present invention.

FIG. 9 illustrates a more detailed view of the processes that may be operative within the server in accordance with one aspect of the present invention.

### DETAILED DESCRIPTION

### Overview

The present invention provides a system, method and computer program that enables delivery of, or access to, a subset of relevant online content, or online content likely to be of interest, from a larger universe of online content. Relevance or likelihood of interest of online content is assessed based on social engagement metrics. Social engagement metrics refers generally to the interaction of a plurality of users in a searchable medium to the online content in question.

The social engagement metrics may suggest, for example, how much the public at large is referring to particular online content, or what it is saying about that online content. This assists in filtering/ranking online content that is less relevant or otherwise unappealing to a particular user, based on the notion that if online content is likely to be interest to many other users, it is also more likely to be of interest to the particular user. Conversely, if online content is being ignored by the public at large, it is more likely than not that the particular user may also ignore the online content, relative to other online content that is generating interest.

One aspect of the invention is that social engagement for online content is assessed relevant to social engagement for similar content, as detailed below. For example, feedback on online content from a particular website is compared to normal feedback for content from the website, thus making it more likely that interaction with the content is due to attributes of specific content rather than popularity of the website generally. The present invention contemplates a number of system aspects, computer program aspects, and method aspects that promote the derivation of information concerning likelihood of interest from social engagement metrics.

It should be understood that the online content may consist of audio, video, images, text, programs (such as Flash™ or Java™-based programs), and any other online content in any media.

The description below provides some example embodiments involving online news articles, but it should be recognized to those skilled in the art that the present invention is easily extendable to other forms of online content.

### System, Method and Computer Program

The present invention relates to a system, method and computer program that is operable for a given data object to obtain social engagement data from a plurality of sources, analyze the social engagement data, and establish a social engagement score. In a further aspect of the invention, a ranking is established for the data object relative to other data objects associated with a user. The user may then select among the ranked data objects a subset that matches his/her level of interest, allowing effective distribution and/or consumption of online content.

One aspect of the present invention is an online content delivery system that enables selective delivery or accessing of online content. The selection of online content occurs by operation of both passive and active feedback from users. “Active feedback” generally refers to qualitative feedback provided by users concerning online content, such as a recommendation of online content to other users, or qualitative feedback provided regarding online content such as a rating (e.g. “Thumbs Up” or “Thumbs Down” or rating on a scale). In contrast, “passive feedback” generally refers to objective interactions between users and online content that while not providing direct qualitative feedback on online content in the nature of active feedback, enables inferences to be made regarding the interest shown by users in the online content. Examples of passive feedback include time spent viewing online content, bookmarking of online content and the like.

It should be understood that the present invention also enables filtering by the user itself through a variety of means such as by selecting the level of interest for online content, as determined by the ranking aspect of the present invention, that the user wishes to receive, and then linking this selection to operation of a filter.

One aspect of the present invention is enabling the collection of social engagement data regarding online content that is based on measurements of both active feedback and passive feedback.

One aspect of the invention is a data processing utility that enables processing of data concerning online content so as to collect and analyze the social engagement data, and then apply the results of such analysis to online content thereby enabling improved delivery or consumption of such online content. An additional aspect of such data processing utility is the ranking of the data objects or specific online content based on relevance and/or reaction thereto as established based on the social engagement metrics, and more specifically a social engagement score calculated by operation of the invention. The details of these aspects of the invention are provided below.

The present invention contemplates linking to, or incorporating, a number of possible functions for enabling a user to obtain a plurality of data objects from one or more sources. It is readily apparent to those skilled in the art that the present invention has particular utility when dealing with either a significant volume of such data objects and/or a large number of sources of data objects. The data objects may come from any number of sources of online content such as publication of an article, publication of a new website, changes to an existing website, an XML feed (including for example the RSS or Really Simple Syndication), press release, and so on.

The present invention contemplates a number of different means for accessing the functionality described.

First, the operator of the system of the present invention provides a website that enables users to provide as input to the website information identifying one or more sources of online content. Based on the invention aspects described above, the website may provide an analysis of online content recently made available by such sources.

Second, associated with the website is a web area that enables users to customize a “My Feeds” section or equivalent that provides a list of online content sources that the users will use for delivery and/or consumption of related content on an ongoing basis. The website, in this particular implementation, provides an online access utility for viewing, downloading or otherwise accessing online content based on the functionality described herein.

Third, the system of the present invention may interoperate with an application linked to the user's computer for accessing the online content, whether provided by the operator of the present invention or a third party, and wherein the system provides a subset of selected online content based on operation of the invention, for example, filtering or ranking of the selected online content by means of the filtering/ranking technology described below.

Fourth, the filtered/ranked online content could be provided as an input into a third party web service associated with the user.

It should be understood that the present invention contemplates use of any means for analyzing online content of interest to a user. For clarity, this may include, for example, integration of aspects of the invention in an application, making same available as a web service, or both.

The present invention, in one aspect thereof, provides a “proxy” that consumes online content on a user's behalf, and then is operable to rank and/or filter the content and enable the delivery of a subset of the online content having improved relevance or likelihood of interest characteristics.

The online delivery management system includes the data processing utility of the present invention. The present invention, in one implementation thereof, may include three utilities: a data collection utility; an analytics utility and a distribution utility. The data collection utility may be operable to search and determine the behavioural and social engagement metrics attached to the electronic information. It may have the ability to effectively prioritize and filter the desired level of interest by assigning weights for attention and interaction to the data source in question. The analytics utility may be operable to assign and optimize the weights through historical analysis of the data source content, past performance and trends. This utility may not require universal measurements and therefore the data may not be skewed by popularity of the site among users. The distribution utility may be operable to enable the delivery of the filtered data source to the user based on his/her specified preference.

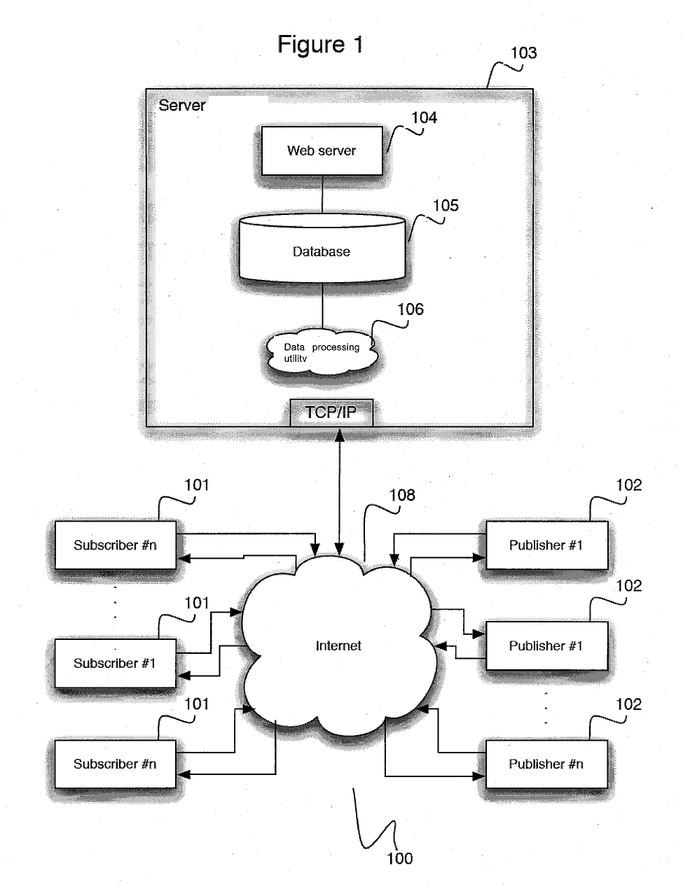

FIG. 1 illustrates a particular implementation of online content delivery system 100 used to transmit or otherwise provide access to online content in accordance with one aspect of the present invention. In accordance with one aspect of the system of the present invention, a server 103 may be configured to send and receive information via an interconnected computer network, such as the Internet 108. Server 103 may include or be linked to a data processing utility 106, which enables analysis of online content and ranking/filtering of online content as described herein.

As mentioned earlier, the present invention enables ranking/filtering of online content of a variety of types. The terms “data” or “data object” are used generically in this disclosure to refer an item of online content.

In a particular example of implementation of the present invention, the data processing utility 106 may be linked to a database 105, which may be employed to store various data intended for use by server 103, which may be implemented using a known web server 104. Data files stored in the database 105 may include any type of information or materials in any medium that each publisher 102 may desire to disseminate electronically in addition to the social engagement data that may be collected by the data processing utility 106 used in the process of ranking/filtering online content. The web server 104, in accordance with one aspect of the invention may retrieve and process information requests related to ranking/filtering of online content from a plurality of users or third party systems linked to the system of the present invention, as described below.

Each publisher 102 may make available a plurality of data files to server system 103 via the Internet 108 for use by users of on-line delivery system 100. This particular aspect is described more fully below.

In one aspect of the present invention, users “subscribe” to the online content delivery system 100 and therefore users of the present invention may be referred to as subscribers 101. Subscribers 101 may access the functions of the system and computer program described from a standard electronic communication device (e.g. a personal computer, wireless handheld, or other computer operable to connect to the Internet or other interconnected network of computers). Subscribers 101 may for example communicate with server system 103 via the Internet 108.

In a particular implementation of the present invention, each personal electronic communication device may include a subscriber application (not shown), which may be configured to communicate with server system 103 in accordance with one aspect of the invention. A subscriber application may consist of an online RSS news-reader, a mobile application for retrieval of news, an aggregator or news portal, or any other computer application designed for retrieval or gathering of data. One aspect of the computer program of the invention therefore is said subscriber application.

In another particular implementation of the present invention, publishers 102 may be news publishers who publish various news publications. Each publisher 102 who desires to make available its publications for online transmission or access may generate corresponding data files containing information regarding such publications. These data files may include audio information, video information, images and other files corresponding to the text of news articles. Some publishers may also desire to make available other updated information throughout the day. For example, blog publishers may prepare several editions of their articles as certain information is updated throughout the day.

As previously described, each publisher may provide its electronic publications in the form of data files, or associated information for identifying particular electronic publications for retrieval or access thereof, to server system 103 in the form of data files. To this end, in one particular embodiment of the invention, the data processing utility 106 may retrieve the data files in order to enable the that the online delivery management system 100 to make the electronic publications available to users, including electronic publications ranked/filtered in accordance with the present invention. The subscriber application of the present invention may enable the personal electronic communications device associated with subscriber 101 to be associated with the server system 103.

The personal electronic communication devices may communicate with server system 103 via a variety of available communication schemes. For example, personal electronic communication devices 101 may establish communications with server system 103 by employing Transmission Control Protocol/Internet Protocol (TCP/IP) sockets. Alternatively, the personal electronic communication devices may communicate with server system 103 via direct network connections.

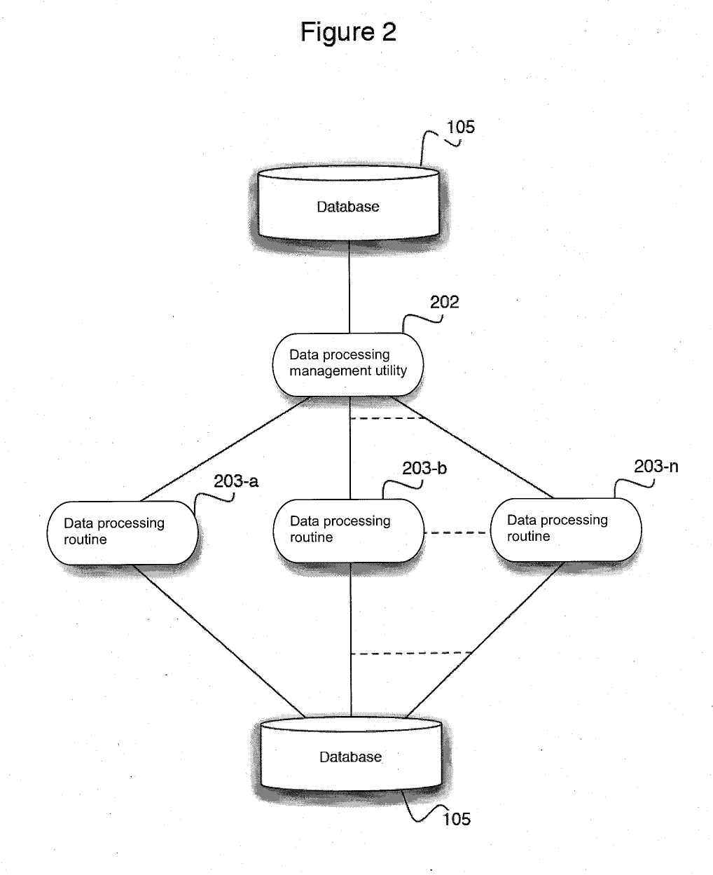

FIG. 2 illustrates an information processing framework of the data processing utility 106 in accordance with one aspect of the invention. Data processing utility 106 may include a data processing management utility 202, which may be operable to control the various operations of data processing utility 106, including as particularized below.

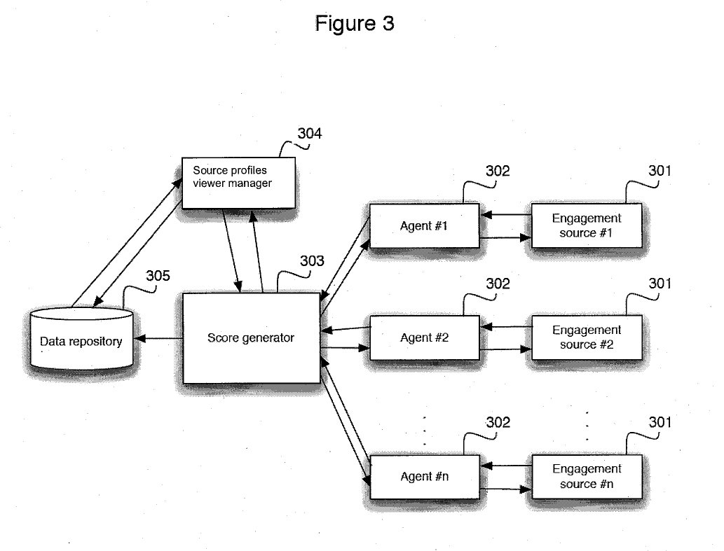

Data processing management utility 202 may for example manage the application of one or more (n) data processing routines such as 203-a through 203-n that are embodied in data processing utility 106, for processing the flow of information retrieved by server system 103. Data processing routines 203 in accordance with one aspect of the invention may each enable the data processing utility 106 to gather social engagement data, as will be explained in more detail in relation to FIG. 3.

Data processing utility 106 may also be linked to a database 105, in which data to be processed may be stored and from which it may be retrieved. Data processing utility 106 may also be linked to a database for purposes of storing the processed results in accordance with one aspect of the invention. Alternatively, the data processing utility 106 may be linked to a series of databases, with a specific database associated with the processing results for one or more data processing routines, and other specific databases associated with the processing results for other one or more data processing routines.

In one aspect of the invention, data processing management utility 202 may be operable to manage the workflow and scheduling of data processing jobs. During the first step, the data processing management utility 202 may be operable to retrieve data objects from the database 105 to be processed and may schedule them for processing based on data processing routines 203.

In a particular aspect of the invention, the data processing management utility 202 may based on a data processing routine 203 retrieve the data objects scheduled for updates, such as, retrieval of new objects from the publisher or checks for changes in social engagement metrics, and initiate the update process. For example, the updates may be received from a local file system in the form of a data file. Alternatively, the file may be received via the Internet 108, a remote procedure call (REST, SOAP, CORBA, etc.), or any other forms of communications interface.

FIG. 3 illustrates in a block diagram some aspects of data processing utility 106 in accordance with one aspect of the invention. The data processing utility 106 may comprise a social engagement retrieval agent 302, a score generator 303, a source profile viewer manager 304, and a data repository 305, which could be a database. Alternatively, a data storage manager (not shown) may perform the role of the data repository 305 for the purposes of storing the retrieved and processed data.

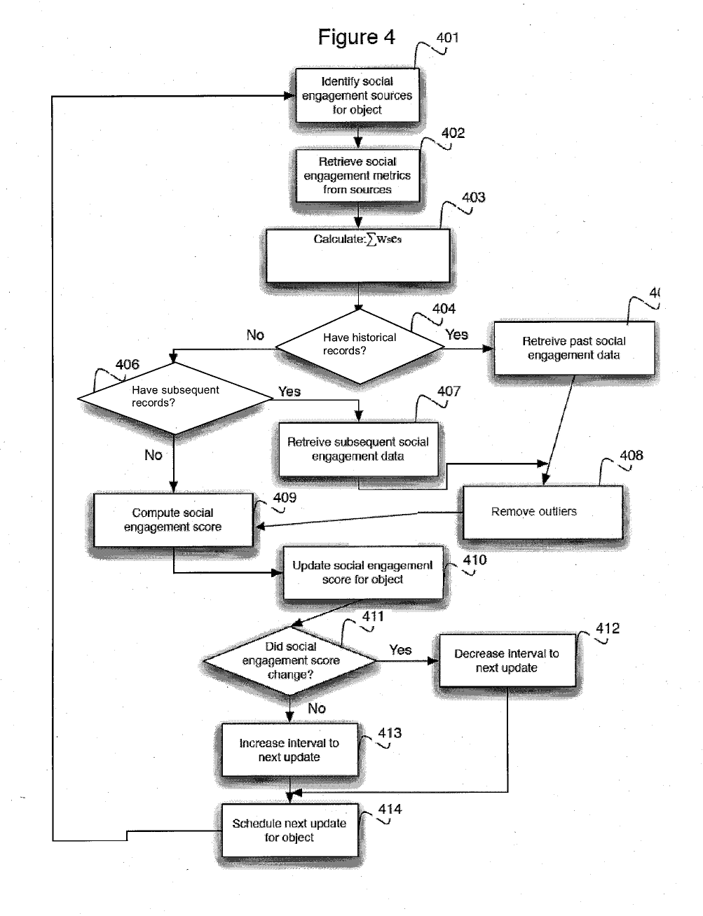

The data processing utility 106 may comprise multiple agents corresponding to the social engagement retrieval agent 302 in order to enable retrieval of social engagement data for each data object supplied by the data processing management utility 202. An agent 302 may comprise of a data retrieval module specific to the underlying communications network (for example, a HTTP client for retrieving web-pages), and an analysis module which processes the retrieved data to extract relevant content from the obtained data. During the first step of retrieving social engagement data, which is further described in FIG. 4, the data processing management utility 202 may assign to each agent 302 the data objects requiring an update and the type of social engagement data to be retrieved, for example, retrieval of specific one or more of the social engagement sources 301. In one particular aspect of the invention, the data processing utility 106 is operable to analyze the data object in question, and based on such analysis, establish the particular social engagement data that will be sought in relation to the data object. For example, based on such analysis, the data processing management utility 202 may assign a particular news article to an agent 302 and specify the category of social engagement sources 301 or for example particular third party sources of social engagement data or specific routines for identifying social engagement data implemented to the social engagement retrieval agent 302, which will be analyzed for the particular news article.

It should be understood that the social engagement sources 301 may vary, however, for the purposes of illustrating the present invention, the following social engagement sources 301 are discussed in the present disclosure: (1) comments, (2) bookmarks, and (3) trackbacks. It should be appreciated that any searchable interaction between users and online content from which level of interest can be inferred may qualify as a social engagement source 301 for the purposes of the present invention. “Comments” generally refers to searchable online comments being made by users associated with a data object. “Bookmarks” refers generally to searchable bookmarking of a data object to a user. “Trackbacks” refers generally to linking back by users to a specific data object. Additional detail concerning social engagement sources 301 are set out below.

In one particular aspect of the invention the social engagement retrieval agent 302 is operable to search the social engagement sources 301 to obtain social engagement data for a particular data object, as the data processing management utility 202 may direct.

The social engagement retrieval agent 302 (or agents 302 providing this functionality) may then provide the collected social engagement data to the score generator 303, which may aggregate the retrieved data for further analysis. To compute the social engagement score for each object, score generator 303 may communicate with historical source profile 304. Historical source profile 304 may be coupled with a data repository 305 for purposes of retrieval of past social engagement scores of data objects having a similar source, type, or description, or other common parameters. Alternatively, the historical source profile data may be provided directly by the data processing management utility 202.

FIG. 4 illustrates the calculation of the social engagement score of a data object, based on the data provided by the agents 302. User engagement may be measured in accordance with various activities, such as bookmarking, commenting, and trackbacks. Initially, each of these activities may be identified 401. Next, the data processing management utility 202 triggers the score generator 303 to rank the data object described herein. The score generator, in a particular implementation of the invention, implements a ranking algorithm that enables the calculations described herein. It should be understood that the present invention contemplates use of different algorithms enabling the scoring functions described herein.

In one particular implementation of the score generator 303, a weighted formula is used to assign more weight to social engagement with online content that is more involved because for example it requires greater effort and the social engagement may suggest a greater degree of interest. For example, in the context of ranking a news article, a bookmark may be considered a relatively low-weight interaction requiring only a few seconds of effort. In this example, the score generator 303 may count access by a bookmark less than a comment or trackback that may be considered to require relatively more time, effort and involvement. In a similar fashion, comments may be assigned less weight than trackbacks since a trackback may presuppose that an individual wrote a follow-up article, and therefore may have invested more time than simply leaving a comment. Therefore, the score generator 303 may first be required to retrieve social engagement metrics 402, such as weights, that correspond to the various activities. These weights may then be used to calculate the engagement score. The following formula is provided as an example of a weighted formula that may be used in accordance with this aspect:

Trackbacks=Technorati+Bloglines+Google+Own search engine

Comments=extracted from the article

Bookmarks=del.icio.us+diggs

Engagement score=0.5*# of Trackbacks+0.3*#of comments+0.2*# of Bookmarks

More generally the present invention may include the following weighted formula 403:

Data Object social engagement score=Σwₛeₛ

Where wₛ is the weight of source s, and eₛ is the social engagement score with respect to source s, as computed by the agent.

Next, historical records of social engagement data corresponding to the data object may be retrieved 404 from a data repository, such as a database 105, or any other form of electronic storage. If historical data is available, the records may be retrieved for further analysis 405. If no historical data is available, then subsequent records may be checked for availability 406. These records may be checked and retrieved by the system for further analysis 407. The use of historical data is illustrated below.

A process of outlier elimination may then be performed on the retrieved data. A method of cross validation such as a k-fold cross validation algorithm may be applied 408. This procedure may allow the score generator 303 to eliminate outliers from the data and may ensure that a very high or a very low engagement score of up to k data objects in the history do not heavily skew the social engagement score of subsequent data objects. For example, all permutations of k-2 subsets may be computed. If k=3 and the values are (1,2,3), then the subsets are as follows:

(1), (2), (3)—total of 3 distinct subsets where k=1

As part of this process, the mean engagement score may be computed for each possible subset derived from the process of k-fold cross validation. Next, the minimum mean social engagement score may be chosen as a baseline for comparison as follows:

Mean social engagement score=Minimum [Mean of each subset (n choose k)]
Where n is the number of historical records and k is the size of the sub-samples.

Finally the ratio of the data object's social engagement score and the mean historical social engagement score may be computed 409 as follows:

Social engagement ratio=Data Object social engagement score/Mean social engagement score

The derived social engagement ratio may serve as an indicator of social engagement for the data object as compared to past source performance. A ratio of 1.0 may translate into a ‘perfectly average’ social engagement, whereas a ratio below 1.0 may translate into less than average social engagement performance and a ratio above 1.0 may translate into a more than average social engagement performance.

The derived ratio may then be mapped with a custom, non-linear function, such as ƒ→[0.10] for purposes of rating and display to the user, in accordance with aspect of the invention. To perform this step, the following non-linear transformation function may be used in one aspect of the invention:

```
if score < 1.0
    return 1 + 4*(score)
else
    return [5 + (score −1), 10].minimum
end
```

In accordance with the above function, the average article may be assigned a score of 5.0. The lowest possible score for any article may be 1.0, and the highest may be 10. The guard condition on the maximum value in accordance with the score generator 303 ensures that even if the article receives 6 times more social engagement than the minimum engagement score, the score may be capped at 10.0.

Next, the computed social engagement score may be stored as an association with the parent data object 410. Then a check may be performed on whether the social engagement score of the data object is changed 411, by operation of the data processing management utility 202. If the score has been updated, the likelihood of subsequent updates may be high and, therefore, the interval for the next update may be decreased 412. Alternatively, if the social engagement score remained the same since the last check, then the update interval may be increased 413. Finally, once the update interval is computed, the object may be scheduled for a subsequent update and the process may be repeated from the start 414.

In one aspect of the invention, when a subsequent update happens, the timestamp for next update may depend on the change in the social engagement score of the data object. If no changes have occurred since the last check, the interval since last check may be increased, such as being doubled. For example, if no changes have occurred since the score generator's 303 first check, the 2 hour interval may be doubled to 4 hours and the next update may be set to: current time+4 hours.

However, in one particular aspect of the present invention, if the engagement score has changed since the last check, the timestamp may be set with respect to a non-linear function having the following properties:
1) If the degree of change has changed less than a specified amount (for example, the degree of change is less than 10% of the last engagement score), the update interval may be kept the same. Hence, if the score changes only slightly since the first check, then the update timestamp may remain as: current time+2 hours, in the above example.
2) If the degree of change has changed more than a specified amount (for example, the degree of change is greater than 10% of the last engagement score), the next update interval may be set with the following function: next update=current time+0.5* last interval, in the above example.

Hence, in the above example, if the score has changed significantly, the timestamp for the next update may be effectively halved.

As another step, in a particular implementation of the present invention, the following boundary conditions on the next update timestamp may be set as:

Maximum interval for next update=current time+5 days 1)

Minimum interval for next update=current time+2 hours 2)

In one aspect of the invention, even if an article is receiving a lot of attention by the minute, the minimum interval for updates may be set to a specified amount such as 2 hours. The update procedure of the present invention represents a trade off between scalability and real-time social engagement monitoring. Alternatively, update intervals may be reduced or extended to create the appropriate balance for user efficiency and effectiveness of finding sought-after objects.

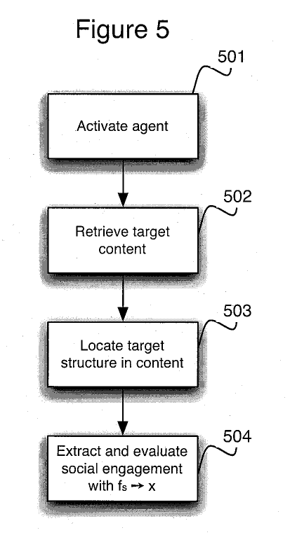

FIG. 5 illustrates activation and extraction of the social engagement score from a single source. The agent may be assigned a social engagement source and the query parameter string may be built to derive the required data 501. The query may then be submitted and the response may be retrieved from the source 502. This communications process may be established by employing TCP/IP sockets. In the alternative, it may be accomplished via a direct modem connection, or any other form of electronic communications.

In one aspect of the invention, a spider may be integrated in the system or computer program of the present invention which may for example have equivalent properties to a software agent, or a single elastic compute cloud (EC2) instance (virtual computer) in the AMAZON™ Web Server (AWS) infrastructure. These spiders may be responsible for retrieving the required data to compute the social engagement score of the data objects (such as a specific article) as well as to retrieve new data objects currently tracked by the system. These spiders may be launched on-demand, depending on the current workload and the amount of updates that need to be processed.

In a particular implementation of the present invention, each spider may dequeue an update packet from the Input Simple Queue Service (SQS) queue, part of the AWS infrastructure, and may launch the update process. One aspect of the present invention may have two types of update packets, and hence two different update procedures:
1. Article updates check—checks if the social engagement score has changed for a collection of articles provided in the updated packet
2. Feed updates check—checks if new stories are available for the collection of XML or RSS feeds provided in the update packet

In both cases, the dequeued packet may contain a list of Universal Resouce Locators (URLs). The spiders may then choose the appropriate update method, check new data objects or retrieve social engagement metrics, and may process the update. Once the updated data is collected, it may be aggregated into another packet, and may be stored onto the Output SQS queue. This process may repeat until all packets in the Input SQS queue have been processed.

In one aspect of the invention, the spiders may process updates in an asynchronous fashion, therefore, a set of discovery servers may be required to process in real-time the retrieval of data for new sought-after objects. For example, if a user comes to a website such as aiderss.com, and enters a new information source identifier (e.g. a URL) which has not been previously analyzed, discovery servers may be used to retrieve the data in real-time. While the data is being collected, the user may be provided with a progress bar which shows what the discovery server is currently doing.

Next, the retrieved content may be analyzed by the agents 302 and the relevant content may be extracted from the response 503. Finally, a source-specific functions ƒₛ→x, described above, may be applied, mapping the extracted content into a numerical score that may represent the social engagement metrics for the object in question as derived from the source 504.

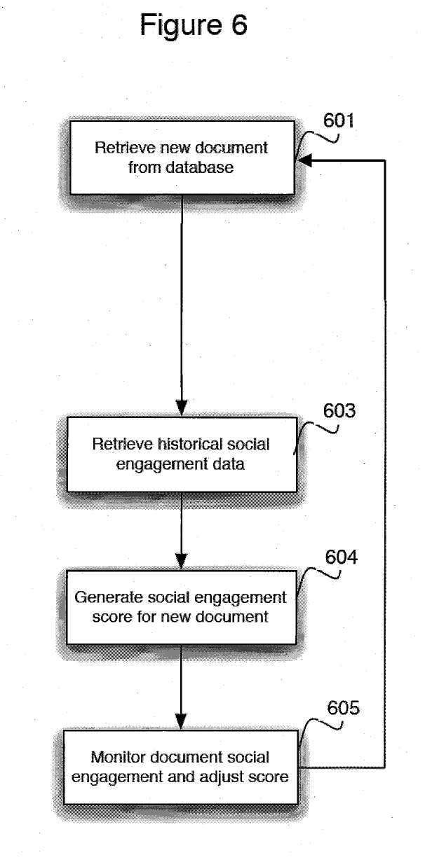

FIG. 6 illustrates a more detailed view of the process of computation and updates of the social engagement score of a data object. The initial step of object retrieval may be from the publisher via a communications network such as the Internet 601.

Next, the agent 302 may compute the social engagement score of a data object that may be of interest to a user. The retrieval of past social engagement scores may then be performed 603, as previously described.

Finally, the algorithm for outlier elimination, previously described, and the social engagement ratio of the data object, as compared to past performance of the source, may be computed 604.

Once the ratio is computed, the score may be persisted in a database 105, in accordance with one aspect of the invention.

Next, the data object may be stored in the system, and periodically, the process may be repeated. While repeating the process the social engagement score may be updated 605. The data processing management utility 106 may be implemented in part as an update manager (not shown) that may run alongside the database 105 and may be responsible for scheduling updates, queueing packets onto the Input SQS queue and dequeueing and processing packets from the Output SQS queue.

In one aspect of the invention, a primary function of update manager may be to select the sought-after data objects to be updated. The update manager may scan the database 105 for entries which require an update, bundle each into appropriate update packets and store them on the SQS queue. When an entry or feed has been selected for update it may also be marked as ‘processing’ by setting an appropriate flag in the database, which may avoid duplicate updates. To select an entry or feed for update, the following conditions may be used:

Time for next update<current time 1.

‘processing’ flag is 0 2.

Once an update packet is stored on the Input SQS queue, the ‘processing’ flag for each entry in the packet may be reset to 1.

Another function of the update manager, in this aspect of the invention, may be to process and persist the updated packets which may then be stored by the spiders onto Output SQS queue. To perform this step, the update manager may continually dequeue packets from the Output SQS queue, and may send an update or insert query into the Database. As part of this process, the ‘processing’ flag may be set to ‘2’, which may mean that the entry has been updated, and the ranking score may need to be recomputed, as described previously.

Finally, the last function of the update manager may be to scan the database 105 for any entries which are marked as ‘processing=2’ and to recompute the updated ranking score for the entry. Once the computation is complete, the new social engagement score, computed with the PostRank™ algorithm described above, may be persisted into the database and the processing flag may be reset to 0.

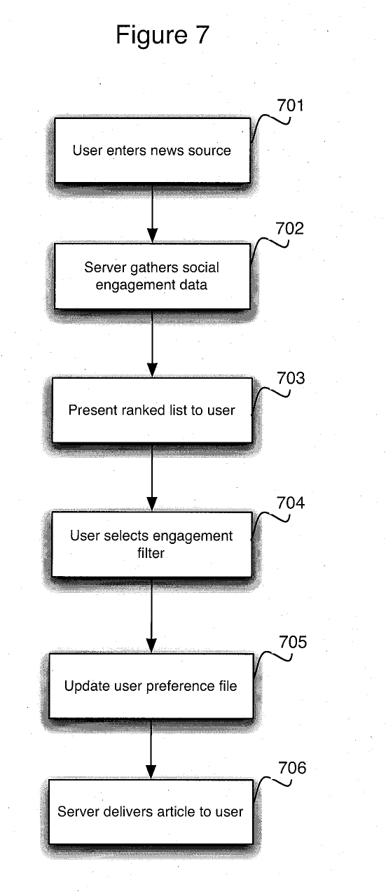

FIG. 7 illustrates a particular aspect of operation of the online content delivery management system 100 wherein users may enter a unique identifier of an information source which they desire to be filtered via social engagement metrics 701. Such an identifier may be a URL for an Internet resource, such as a blog, a news site, database, or any form of an online data source.

Next, the system may retrieve and gather the social engagement data about each data object generated by the data source 702. Once the engagement data is retrieved, a list of data objects and their associated social engagement scores may be presented to the user 703, allowing the user to quickly gauge the level of attention he/she should assign to each data object.

Next, based on the observed ranking, the user may select the desired filtering level for the data source 704. Depending on the level of interest in the subject or generating data source, the user may choose between a tradeoff of receiving more information with potentially lower social engagement scores, or less information but with higher social engagement scores.

In one example of the invention, the user may select from among the following filters: all, good, great, best. For example, these filters may translate into the following score conditions by operation of the present invention:
All (PostRank>0.0)—send all articles.
Good (PostRank>=2.7)—only articles which are slightly above the half-median social engagement score
Great (PostRank>=4.7)—only articles which received (almost) median social engagement, or more.
Best (PostRank>=6.5)—only articles which received 2.5 times, or more, of social engagement, when compared to past social engagement performance.

Next, the user preference may be saved 705 for the selected data source in a database 105. Finally, articles may be delivered to the user in a chosen format based on the selected level of filtering 706. The data may be presented in a variety formats, such as HTML pages, RSS feeds, email delivery, SMS messages, etc.

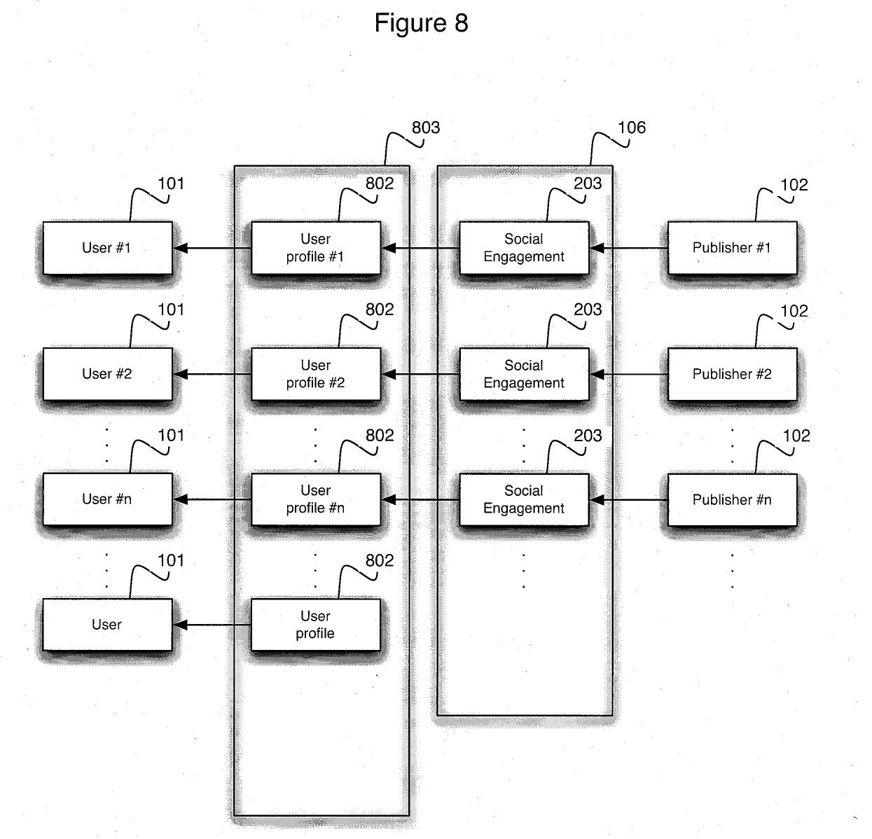

FIG. 8 illustrates the data retrieval and delivery components of ranking/filtering in accordance with one aspect of the invention. The publisher 102 may be responsible for generating the content, which may be retrieved by the server system 103, and may be processed by the data processing utility 106. Specifically, the processor 203 may provide the social engagement scores 203. The social engagement scores 203 for each sought-after data object may be calculated, as previously described, and the resulting object and social engagement scores may be persisted in a database 105, or another form of data storage and retrieval system.

Next, a user preference profile 802 may be built, as previously illustrated in FIG. 7. Since there may be many subscribers to one data source, user preference profiles may be stored in a database 105 and processed independently by the server 803. A subscriber 101 may then retrieve the filtered data from the on-line delivery management system 100 in a preferred format, which may include HTML, RSS, XML, or any other well-structured format.

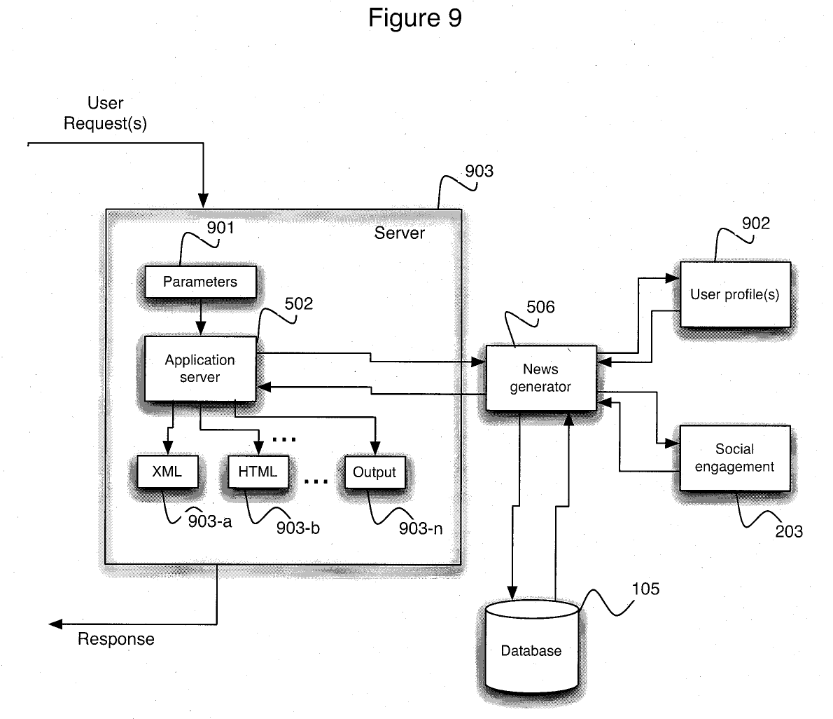

FIG. 9 illustrates some of the components of the server system 903, and a detailed overview of the components of the application server 502 in accordance with one aspect of the invention. The server system 903 may comprise parameters 901 supplied by the user, an application server 502, and a collection of output formats 903a-n. The parameters 901 may be supplied by the user when a request is made over the communications network. These may include a data source, a user id, a timestamp, preferred filtering level, and further customizations which help the user retrieved the desired view of the data. The parameters 901 may then be passed to the application server 502 which is responsible for generating the requested view of the data.

In a particular implementation of the invention, the application server 502 may be linked to a news generator 506, which may be associated with a with a user profile 902, social engagement system 203, and database 105 components. The news generator 506 may be responsible for communicating with all other components in order to materialize the requested view of the data. To perform this task, the news generator 506 may retrieve, via the application server 502, the user profile specified in the parameters 901, and may then request all data objects from the database 105 which match the user profile and provided parameters 901. Next, the retrieved data objects may be filtered with respect to their social engagement scores, the specified social engagement preferences in the user profile 902 and/or the provided parameters 901.

Next, the application server 502 may convert the returned data objects into an output format 903a-n. The output formats may vary and be specified by the parameters. An example of an output format may include an HTML page, an RSS feed, or any other form of a well-defined data structure. Resulting data may then be returned to the user.

### Social Engagement Sources

As an example of a computation of the engagement score of a sought-after object, the following sources may be used:
Original entry (e.g. blog post or news article) comments section
   The spider may download the content of the page and extract all of the available comments. In one aspect of the invention, it may then only save the count (number of comments) and discard all other information. In the alternative, it may retain and/or analyse these comments.
Digg: number of times an item has been dugg (voted for) on digg.com
   Users may submit stories to digg.com and other users may have a chance to vote on each story. If a story becomes popular, it may appear on the top page or in a sub-section of the web-site. In one aspect of the invention, the spider may count the number of ‘diggs’ as a ‘bookmark’ in the system.
del.icio.us: number of bookmarks.
   del.icio.us is an online bookmarking system. Users can store their bookmarks and comments associated with each in the del.icio.us database. The spiders may query the del.icio.us servers to find out if the current article has been bookmarked by anyone, and if so, how many bookmarks have been submitted for that URL.
Google, Technorati, Bloglines, own search engine: number of trackbacks.
   A trackback is a link back to the article. When a user writes a blog-post or publishes an online article, they may provide a link to an article they are discussing or referencing in their own publication. A number of online search engines, such as Google Blog Search, Technorati, IceRocket, and Bloglines track the number of cross-referencing links, and the spider may retrieve this information from the search results.

### Possible Aspects of the Invention

### Large E-Commerce Retailers

In one particular implementation of the invention, in one aspect the technology may be applied to large e-commerce catalogs such as AMAZON online shopping. Typically these catalogs contain thousands of items. It can be difficult to find the authoritative book on a subject where many have been published. Also, as new books are published on a topic such as marketing, it is difficult to separate the classics from the briefly trendy.

To assist the customer in making his/her selections, vendors such as AMAZON have provided metrics including explicit data such as product reviews, buyer statistics, product recommendations, vendor ratings, and overall sales rankings. Furthermore, AMAZON customers can generate lists of recommended products to assist other customers in selecting the best products. Implicit data is also available in the form of customer wish-lists and via external (non-AMAZON) blogs which review products sold on sites such as AMAZON.

Using the ranking generator 303 coupled with topic detection methods, blog articles that review specific books may be identified. The same social engagement metrics may be applied to AMAZON's or other large retailers' customer wish-lists to determine the desirability of each item. Sentiment detection methods may then be applied to the blog entries as well as the customer product reviews at the AMAZON site to assess, in addition to the ‘star’ ratings, positive, negative and neutral reviews and commentary on catalog items. Lastly the temporal qualities of each the above may be used to ascertain if the desirability is sustained, increasing or decreasing over time. This data coupled with AMAZON's or other large retailers' sales rankings and product recommendations may be used in a weighted calculation to determine the overall desirability of each item in any catalog.

With the catalog classified, customers looking for the best products, for example a book on marketing high technology products may enter that topic in a search box. The query may then identify a candidate set of books, ranked by desirability as calculated above. A personal classifier may then be used to filter the candidate set removing previously purchased books. The same previously purchased books can be used to fine tune the candidate set by boosting titles that have been purchased by others with similar interests based on past purchase history. With the collection of filters applied, an ordered list, ranked by overall desirability may be returned to the customer.

### News

In a particular implementation of the present invention, the technology may be applied to classify online blogs that are published in the form of RSS feeds. RSS makes it easy for users to centralize multiple information sources into a single RSS reader such as Google Reader™. Because it is easy to subscribe to RSS feeds, users typically amass a substantial number (e.g. 20 plus) of feeds. Many online blogs publish articles frequently. Some that might be considered more mainstream blogs publish multiple articles each day. Users begin to experience information overload due to this volume and frequency and they require a better way to identify and select articles that match their interests.

RSS feeds can be assigned a desirability index to facilitate this identification and selection of articles. Once articles are published at each blog, social engagement metrics may be gathered from Internet sites such as Digg.com, del.icio.us, Technorati, etc. to gauge reader reaction to the post. Trackbacks, further online blog articles referencing and in response to a particular article, as well as the number of comments in response to each article may be collected. A weighted calculation may be performed to determine the desirability of each article. The results of this calculation may then be compared to past article performance to determine if the desirability of the online blog is increasing, decreasing or stable over time.

To facilitate the selection of articles of interest, users may be provided with a website to specify the filtering level of their RSS feeds on a grouping of, for example, All, Good, Great or Best. This grouping may be based on the individual desirability calculation of each article. This may enable users that have a deep interest on a topic to filter Good articles which only applies the minimum level of filtering of non-desirable articles. For topics which the same user may only monitor casually, he/she may select Best which only presents the significant and thus highly desirable articles for the user's reading.

Typically RSS readers have only one pivot point and present online articles only in reverse chronological order. By assigning each object a desirability index value these objects can now be ordered by this ranking to allow users to read the most desirable and thus most relevant articles first.

### Mobile

In yet another implementation of the invention, the system of the present invention is deployed in connection with mobile devices. Even with filtered feeds, a user may still receive hundreds of RSS items/day. Sending hundreds of RSS items to a mobile device is infeasible due to both the bandwidth requirements as well the technical limitations of many devices. A classification system which identifies the highly desirable articles coupled with the recognition of the need for a mobile friendly delivery format will optimize the RSS reading experience on a mobile device.

Once a user has specified his/her RSS feeds in the aspect above, he/she may select the option of “Sync to Mobile” and automatically only the “Best” feeds may be directed to his/her mobile device to reduce both the network traffic and consequently carrier charges. The user may optionally set any of the other levels, such as Good or Great, as the minimum that may be sent to their mobile device.

To further minimize bandwidth and to accommodate the reduced screen real estate, the mobile feed may be summarized and presented in a form similar to RSS partial feeds. Each RSS object may have a MORE link that retrieves the full/original story content at the user's discretion.

### Extensions to the Technology

The disclosure discusses certain system components, software components, or other utilities, as means for illustrating the operation and implementation of the present invention. It should be understood that the present invention may not be limited to particular software, system, or network architectures or configurations, or to specific allocations of resources or functionality as between particular system components, software components, or other utilities. It should be understood that one or more system components, software components, or other utilities, could be provided as a greater or lesser number of system components, software components, or other utilities. A number of software components described (for example the subscriber application) could be pre-loaded on a personal communication device. The present invention is not limited to any particular software structure, including any modular structure. It would be obvious to a person skilled in the art that various additional features could be included in the system and computer program of the invention. For example:
1. Keyword filtering. The present invention contemplates addition (for example to the functions of the data processing utility) of various other filtering mechanisms that enable filtering or sorting of user's online content, such as his/her feeds, for example using keywords or forms of Boolean search. For example the present invention may be configured to only provide stories which contain word ‘apple’.
2. Categories. The present invention also involves integrating in the functions of the system, computer program or website discussed above various features for organizing different sources of online content, or specific online content, such as for example categories that enable the user to organize sources of online content into different categories for easier sorting, reading and prioritization.
3. Clustering & Topic detection. The present invention also contemplates integration of artificial intelligence and machine learning to assist in the ranking/filtering functions described. For example, ratification intelligence and machine learning could be used to gather similar stories and remove duplicate stories—presenting the user with only the best sources/articles.
4. Recommendation utility. The present invention could also include a recommendation utility that may provide recommendations on online content that the user may want to read based on the user's current preferences, habits and reading.
5. Personalization. The present invention may also be extended by incorporating systems, computer programs or methods to help train the system on what the user would like to see more and less of in the future, including based on active feedback and passive feedback.
6. Web browser toolbar. The present invention also contemplates providing custom toolbars for enabling interaction with the disclosed technology. For example, a custom toolbar may be provided for a web browser computer program (such as Mozilla™ Firefox™ to enable visits to tap into a central data repository. For example, the present invention can provide the top stories of any blog, display the ranking provided in accordance with the present invention regarding a data object such as an article that the user is current reading, or provide blog and/or story recommendations—all through a single toolbar.
7. Analytics. Analytics tools may be incorporated into the system or computer program, or linked to the same, for example to provide statistics and other data to publishers to help them understand readership, trends, levels of social engagement, etc.
8. Widgets. It should be understood that aspects of the present invention can be implemented as computer code in order to provision and enhance the functionality of websites. For example, the invention could be implemented as a widget, i.e. a self-contained snippet of code which is inserted into a web page and provides some standalone functionality. The present invention may provide widgets for publishers to display their top stories from past day, week, month, year. The present invention may also provide recommendation widgets for specific blog posts, and feeds. The widgets could also be used to update content to a website automatically with data objects likely to be of interest.
9. Advertising. The present invention may collect behavioural and contextual data about RSS feeds and the users. The present invention may thus be used to deploy either contextual or behavioural based ads within the feeds.
10. Contextual delivery. The present invention may also be enhanced by providing contextual content delivery, for example by varying context (e.g. geographic location—in office, on the road) in order to affect ranking/filtering. If the user is on a BlackBerry™ device, he/she may want to receive less information, unless it is top news or high priority. The present invention can provide the tools which will enable this level of service.
11. International data sources. The present invention may be configured by the user such that the spiders are restricted to retrieving content and social engagement scores (for example bookmarking sites, blog search engines, etc.) localized in specific geographic locations such as United States, North America, Europe, Asia, etc.
12. Sentiment analysis. The present invention may collect users' comments, but discard the content. As an additional input, the present invention may capture the sentiment of the comments (positive/negative, objective/subjective, etc.), and use this data as an additional input for ranking/filtering functions.
13. Detection of influencers/authority. Based on the retrieved contents of the story, the comments, and past performance of the blogger or source, the present invention may start inferring the topic influencers and/or authority of any given article. This functionality may tie back into the clustering and recommendation functions.
14. Visualization widgets. The present invention may provide visualizations of information velocity, changes in sentiment, and topic boundaries using stored historical ranking data.
15. Analysis of line content. It should be understood that the present invention may be combined with other techniques or technologies for analyzing the content of data (for example video or audio analysis techniques or technologies, or Natural Language Processing), and then for example providing the ranking techniques described herein.
16. Integration. The functionally described herein could be integrated into other products such as a news reader, an RSS reader application, or other applications designed for retrieval of data.

1. A method for delivering online content comprising the steps of:
providing access to online content including a plurality of data objects;
obtaining information regarding the relevance of and/or likelihood of interest in the data objects by searching for online social engagement with the data objects by one or more users, so as to define social engagement data; and
ranking and/or filtering the data objects for relevance of and/or likelihood of interest based on the social engagement data.

2. The method of claim 1 wherein the social engagement data includes searchable engagement of the one or more users with the data objects.

3. The method of claim 2 wherein the social engagement data is compared and adjusted relative to social engagement data for similar data objects.

4. The method of claim 1 wherein the ranking and/or filtering establishes a social engagement score for the data objects.

5. The method of claim 1 wherein the ranking and/or filtering is based on a combination of active feedback and passive feedback from users regarding the data objects.

6. The method of claim 1 comprising the further step of enabling a subscriber to define parameters for ranking and/or filtering of online content.

7. The method of claim 1 comprising the further step of accumulating historical social engagement data for the data objects and linking the historical social engagement data to ranking and/or filtering of online content.

8. The method of claim 1 comprising the further step of analyzing the data objects, and based on such analysis adjusting one or more of the particular social engagement data that is obtained for the particular data objects and the ranking and/or filtering of the data objects.

9. An online content delivery system comprising:
a server computer connected to an interconnected network of computers;
a server application linked to the server computer, the server application including a data processing utility, the data processing utility being operable to enable the server computer to:
provide access to online content including a plurality of data objects;
obtain information regarding the relevance of and/or likelihood of interest in the data objects by searching for online social engagement with the data objects by one or more users, so as to define social engagement data; and
rank and/or filter the data objects for relevance and/or likelihood of interest based on the social engagement data.

10. The system of claim 9 wherein the social engagement data includes searchable engagement of the one or more users with the data objects.

11. The system of claim 9 wherein the data processing utility is operable to compare and adjust the social engagement data relative to social engagement data for similar data objects.

12. The system of claim 9 wherein the data processing utility is operable to rank and/or filter the online content by establishing a social engagement score for the data objects.

13. The system of claim 9 wherein the data processing utility is operable to rank and/or filter the online content based on a combination of active feedback and passive feedback from users regarding the data objects.

14. The system of claim 9 wherein the data processing utility is operable to enable a subscriber to define parameters for ranking and/or filtering of online content.

15. The system of claim 9 wherein the server computer is linked to a database, and the data processing utility is operable to accumulate and store to the database historical social engagement data for the data objects, and wherein the data processing utility is further operable to retrieve the historical social engagement data and process the ranking and/or filtering of online content including based on said historical social engagement data.

16. The system of claim 9 wherein the data processing utility is further operable to analyze the data objects, and based on such analysis to adjust one or more of the particular social engagement data that is obtained for the particular data objects and the ranking and/or filtering of the data objects.

17. The system of claim 9 wherein the server computer is operable to act as a proxy for a subscriber so as to consume online content on behalf of the subscriber, rank and/or filter the online content, and enable delivery to the subscriber of a subset of online content having improved relevance or likelihood of interest characteristics.

18. The system of claim 9 further comprising at least one remote computer associated with a subscriber and connected to the interconnected network of computers, the server computer being operable to enable delivery to the remote computer of a subset of online content having improved relevance or likelihood of interest characteristics.

19. The system of claim 18 wherein a subscriber application is linked to the remote computer, the subscriber application being operable to enable the subscriber to access the functions of the data processing utility from the remote computer.

20. A computer program for enabling online content delivery, the computer program comprising computer instructions, which when made available to a server computer define a server application, the server application including a data processing utility, the data processing utility being operable to enable the server computer to:
provide access to online content including a plurality of data objects;
obtain information regarding the relevance of and/or likelihood of interest in the data objects by searching for online social engagement with the data objects by one or more users, so as to define social engagement data; and
rank and/or filter the data objects for relevance and/or likelihood of interest based on the social engagement data.

21. A computer program for enabling online content delivery, the computer program comprising computer instructions, which when made available to a computer defines on the computer a subscriber application, the subscriber application being operable to enable the computer to communicate with a server computer, the server computer including a server application, the subscriber application being operable to enable a subscriber to initiate the server application to:
provide access to online content including a plurality of data objects;
obtain information regarding the relevance of and/or likelihood of interest in the data objects by searching for online social engagement with the data objects by one or more users, so as to define social engagement data; and
rank and/or filter the data objects for relevance and/or likelihood of interest based on the social engagement data.
